(19) United States
(12) Patent Application Publication
(10) Pub. No.: US 2025/0019209 A1
(43) Pub. Date: Jan. 16, 2025

(54) ELEVATOR WEIGHT HAVING HANDLE AND MANUFACTURING METHOD THEREFOR

(71) Applicant: Eung Joo KIM, Seoul (KR)

(72) Inventor: Eung Joo KIM, Seoul (KR)

(21) Appl. No.: 18/684,447

(22) PCT Filed: Aug. 18, 2021
(86) PCT No.: PCT/KR2021/010978

§ 371 Date: Feb. 16, 2024

(51) Int. Cl. B66B 17/12

(52) U.S. Cl. CPC B66B 17/12

(57) ABSTRACT

An elevator weight having a handle of the present invention is manufactured by the steps of: (a) preparing a rectangular case formed of a metal or resin-based material, and having an empty interior; (b) forming a pair of through holes for fixing a handle on side surfaces of both ends of the case; (c) inserting an end of a metal rod by a predetermined depth into the pair of through holes formed in step (b), and then temporarily fixing the metal rod to the case; (d) charging a filling compound inside the case in which the metal rod is temporarily fixed; (e) after step (d), curing charged mortar for a predetermined time outdoors such that the end of the temporarily-fixed metal rod is embedded in the mortar, and at this time, the metal rod protruding outside the mortar forms a handle.

### TECHNICAL FIELD

The present invention relates to an elevator weight having handles and a manufacturing method therefor, and more particularly, the present invention relates to an elevator weight having handles and a manufacturing method therefor, in which a handle is integrally installed on both ends of a weight, which is a weight installed as a counterweight of an elevator, to use the handle when a worker transports the weight or installs the weight in the elevator, so that convenience and safety of the worker are significantly improved as compared with a conventional weight having a general shape without a handle.

### BACKGROUND ART

In general, an elevator installed in a building to transport passengers or cargo is equipped with weights as counterweights to maintain the weight and balance of a lifting/lowering body of the elevator.

Such a weight is mainly formed of a steel plate, cast iron, or a cement mixture, and a plurality of weights are stacked and installed within a weight fixing frame suspended from one end of a rope for lifting and lowering the elevator on an opposite side of the lifting/lowering body. In this case, the weight plays an important role in reducing driving energy of the elevator by reducing the weight of the lifting/lowering body hung on a pulley.

FIG. 1 is a view showing configurations of a weight fixing frame and a weight of an elevator according to one embodiment of the related art, in which (a) is a plan view, and (b) is a front view.

Regarding configurations of a weight fixing frame 2 and a weight 3 of an elevator according to the related art, a plurality of weights 3 were fitted and loaded into the weight fixing frame 2 having a ‘␣’-shaped section so as to be fixed, or the weights 3 were fitted and loaded into the weight fixing frame 2 having the ‘␣’-shaped section and fixed with a fixing bolt 5 as shown in FIG. 1.

Regarding the above configuration in more detail, first, both ends of each of the weights 3 provided within the weight fixing frame 2 having the ‘␣’-shaped section may be sequentially fitted and stacked into the frame 2 (see FIG. 1a).

Next, a rod-shaped fixing bolt 5 having a predetermined length may be vertically fitted and inserted into a bolt insertion hole 4 formed in middle portions of both sides of the weight 3, so that the weight 3 may be fixed so as to be prevented from being separated from the weight fixing frame 2 (see FIG. 1b).

Meanwhile, the weights having the above configuration may generally be manufactured by stacking a plurality of layers of iron plates, manufactured through casting by using cast iron, or manufactured by using a cement mixture. Among the above methods, according to the method of using the cement mixture, in most cases, the manufacturing may be performed by forming an integrated case first, mixing concrete, sand, a weighted metal, and a metal oxide, and injecting the mixture into the integrated case.

However, since the conventional elevator weight manufactured as described above has a heavy weight, it may be very difficult to handle the conventional elevator weight. For this reason, there were serious problems in which negligent accidents such as a hand of a worker being caught in the weight frequently occurred in a process of transporting the weight and installing the weight in the elevator by the worker.

### Disclosure

### Technical Problem

The present invention has been devised to solve the problems of the related art, and an object of the present invention is to provide an elevator weight having handles and a manufacturing method therefor, in which a handle may be integrally installed on both ends of a weight, which is a weight installed as a counterweight of an elevator, to use the handle when a worker transports the weight or installs the weight in the elevator, so that convenience and safety of the worker may be significantly improved as compared with a conventional weight having a general shape without a handle.

### Technical Solution

To achieve the above object, according to one embodiment of the present invention, there is provided a method for manufacturing an elevator weight having handles, the method including: (a) preparing a rectangular case formed of a metal or a resin-based material and having an empty interior; (b) forming a pair of through-holes for fixing a handle on side surfaces of both ends of the case; (c) inserting an end of a metal rod having a predetermined shape by a predetermined depth into the pair of through-holes formed in the step (b), and temporarily fixing the metal rod to the case; (d) charging a filling compound inside the case in which the metal rod is temporarily fixed; and (e) curing, after the step (d), charged mortar for a predetermined time outdoors such that the end of the temporarily-fixed metal rod is integrally embedded in the mortar, in which a portion of the metal rod protruding outside the mortar forms the handle.

In addition, according to one embodiment, in the step (c), an overall shape of the metal rod may be a ‘U’ shape, a ‘↑’ shape, or a ‘∥’ shape so that both ends of the metal rod having the ‘U’ shape, the ‘↑’-shape, or the ‘∥’ shape are inserted by the predetermined depth into the pair of through-holes formed in the step (b), and the metal rod is temporarily fixed to the case.

In addition, according to one embodiment, the step (d) may include: (d1) forming a weight mortar through mixing by inputting water and iron powder to cement at a predetermined ratio according to a desired target weight; (d2) charging the weight mortar formed through the mixing inside the case in which the end of the metal rod is temporarily fixed; and (d3) curing the charged mortar for the predetermined time outdoors such that the end of the temporarily-fixed metal rod is integrally embedded and fixed in the mortar.

In addition, according to one embodiment, the method may further include: (f) a post-processing step of performing, after the step (e), finishing by applying a rustproofing paint to a surface of the rectangular case formed of the metal, the filling compound charged inside the case, or the metal rod.

In addition, according to one embodiment, a screw thread may be formed on circumferential surfaces of the both ends of the metal rod having the ‘U’ shape, the [symbol] shape, or the [symbol] shape, and a temporarily fixing nut may be screw-coupled to the screw thread while the both ends of the metal rod on which the screw thread is formed are inserted by the predetermined depth into the pair of through-holes, so that the metal rod having the ‘U’ shape, the [symbol] shape, or the [symbol] shape is temporarily fixed to the case.

In addition, according to another embodiment, the through-hole and a circumference of the round rod inserted into the through-hole may be welded to each other while the both ends of the metal rod having the ‘U’ shape, the [symbol] shape, or the [symbol] shape are inserted by the predetermined depth, so that the metal rod is temporarily fixed to the case.

In addition, according to the present invention, there is provided an elevator weight having handles, which is manufactured by one of the method described above.

In addition, according to one embodiment, an elevator may be further provided with rod-shaped separation prevention support members, and the metal rods, which serve as handles for a weight, may be fitted to the separation prevention support members, respectively, so that the weight is fixed so as to be prevented from being separated from the separation prevention support member.

In addition, according to another embodiment, a weight fixing frame may be further provided at a periphery of the rod-shaped separation prevention support member, and the metal rods, which serve as the handles for the weight, may be fitted to the separation prevention support members, respectively, so that the weight is fixed so as to be prevented from being separated from the separation prevention support member and the weight fixing frame.

### Advantageous Effects

According to an embodiment of the present invention, a worker may lift and transport a weight by using handles provided to the weight, or may install the weight by fitting the handles to a weight fixing frame, so that work convenience can be improved, and worker safety can be significantly improved by preventing an accident in which a finger of the worker is caught between weights in a transportation or installation process.

In addition, the weight may be fixed by fitting the handle into a conventional weight fixing frame having a general structure in which a horizontal section has a ‘␣’ shape, and a rod-shaped separation prevention support member that stands vertically and has an open top may be further provided in the weight fixing frame of an elevator in replacement of the weight fixing frame or in addition to the weight fixing frame so as to vertically fit handles of weights to tops of separation prevention support members, respectively, so that the weight can be fixed more stably so as to be completely prevented from being separated from the weight fixing frame.

### DESCRIPTION OF DRAWINGS

FIG. 1 is a view showing configurations of a weight fixing frame and weights of an elevator according to one embodiment of the related art, in which (a) is a plan view, and (b) is a front view.

FIG. 2 is a view showing an elevator weight having a handle according to one embodiment of the present invention, in which (a) is a plan view, (b) is a front view, and (c) is a right side view.

FIG. 3 is a view showing a state in which a ‘U’-shaped metal rod, which is to be a handle, is temporarily fixed to a case by a screw coupling scheme according to one embodiment of the present invention.

FIG. 4 is a longitudinal sectional view illustrating a state in which an elevator weight having a handle according to the present invention is mounted on a weight fixing frame of an elevator.

### MODE FOR INVENTION

The following detailed descriptions of the present invention are given for embodiments in which the present invention may be practiced, and refer to the accompanying drawings that illustrate the embodiments. These embodiments are described in sufficient detail to enable those skilled in the art to practice the present invention. It is to be understood that various embodiments of the present invention are different from each other, but need not be mutually exclusive. For example, specific shapes, structures, and characteristics described herein may be implemented and changed from one embodiment to another embodiment without departing from the idea and scope of the present invention. In addition, it is to be understood that positions or arrangements of individual elements in each embodiment described herein may be changed without departing from the idea and scope of the present invention.

Therefore, the following detailed description is not to be taken in a limiting sense, and the scope of the present invention is defined only by the appended claims while encompassing the scope of all equivalents of the claimed invention when appropriately described. In the drawings, like reference numerals refer to elements that perform the same or similar functions across various aspects.

Regarding the terms used herein, general terms that are currently used as widely as possible are selected in consideration of functions thereof in the present invention. However, the terms may vary according to the intention of those skilled in the art, judicial precedents, the emergence of new technologies, and the like. In addition, in certain cases, a term may be selected at discretion of the applicant. In this case, the meaning of the term will be described in detail at a corresponding part in the description of the invention. Therefore, the terms used herein are to be defined based on the meanings of the terms and the overall contents of the present invention without being simply limited to names of the terms.

Throughout the present invention, when some part “includes” some elements, unless explicitly described to the contrary, it means that other elements may be further included but not excluded. In addition, any term including “part”, “module”, and the like used in the specification refers to a unit for processing at least one function or operation, and may be implemented as hardware, software, or a combination of hardware and software.

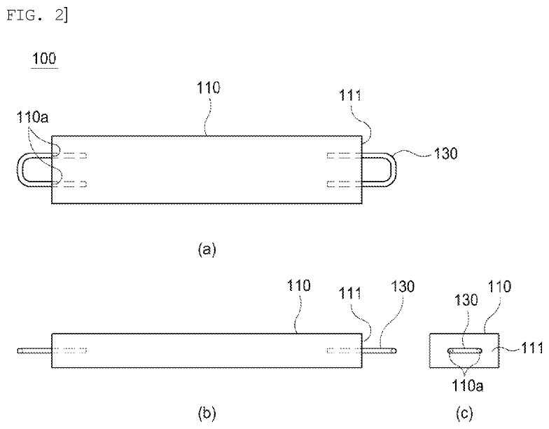

Hereinafter, a configuration and an operational relation of an elevator weight having a handle according to the present invention will be reviewed in detail with reference to the accompanying drawings of FIGS. 2 to 4.

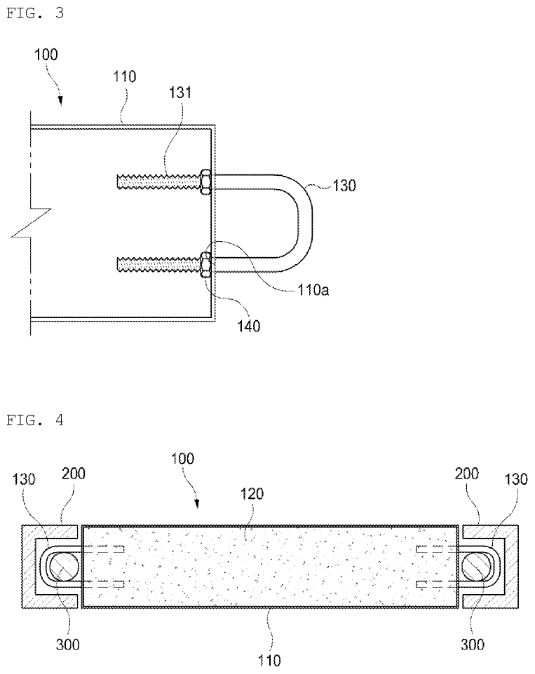

Among the accompanying drawings, FIG. 2 is a view showing an elevator weight having a handle according to one embodiment of the present invention, in which (a) is a plan view, (b) is a front view, and (c) is a right side view, FIG. 3 is a view showing a state in which a ‘U’-shaped metal rod, which is to be a handle, is temporarily fixed to a case by a screw coupling scheme according to one embodiment of the present invention, FIG. 4 is a longitudinal sectional view illustrating a state in which an elevator weight having a handle according to the present invention is mounted on a weight fixing frame of an elevator.

First, a method for manufacturing an elevator weight 100 having a handle according to one embodiment of the present invention may be performed in the following steps.

Step (a): Prepare a rectangular case 110 formed of a metal or a resin-based material and having an empty interior.

The rectangular case 110 may be formed of various types of materials such as a metal such as a steel plate, or a resin.

In this case, when the resin is used, the resin may generally be cheaper than the steel plate and may not corrode. However, the resin except for special plastics such as fiber-reinforced plastic (FRP) may have weak durability so as to be prone to breaking or tearing, so that the steel plate may be more advantageous than the resin in terms of durability or a load.

Step (b): Form a pair of through-holes 110a for fixing a handle on side surfaces 111 of both ends of the case 110.

Step (c): Insert both ends of a metal rod 130 having a predetermined shape by a predetermined depth into the pair of through-holes 110a formed in the step (b), and temporarily fix the metal rod 130 to the case 110.

In this case, according to one embodiment, an overall shape of the metal rod 130 may be implemented in various shapes such as a ‘U’ shape or a [symbol] shape having one end that is connected, or a [symbol] shape having both ends that are separated.

In addition, regarding a process of temporarily fixing the metal rod 130, according to one embodiment shown in FIGS. 2 to 4, a screw thread may be formed on a circumferential surface of an end 131 of the metal rod 130 having the ‘U’ shape, and a temporarily fixing nut 140 may be screw-coupled to the screw thread of the end 131 while the end 131 of the metal rod 130 on which the screw thread is formed is inserted by the predetermined depth into the pair of through-holes 110a, so that the metal rod 130 having the ‘U’ shape may be temporarily fixed to the case 110.

In addition, according to another embodiment, the through-hole 110a and a circumference of the round rod 130 that is adjacent to the through-hole 110a may be welded to each other while the end 131 of the metal rod 130 having the ‘U’ shape on which the screw thread is formed is inserted by the predetermined depth into the pair of through-holes 110a, so that the metal rod 130 having the ‘U’ shape may be temporarily fixed to the case 110.

Step (d): Charge a filling compound inside the case 110 in which the metal rod 130 is temporarily fixed.

In this case, the filling compound charged in an empty space inside the case 110 may be a major element for adjusting a load of the weight according to the present invention, and may be mortar such as cement or a mixed compound according to various embodiments.

Among the above examples, when the mortar is used as the filling compound, the step (d) may be performed in the following detailed steps (d1) to (d3).

Step (d1): Form a weight mortar 120 through mixing by inputting water and iron powder to cement at a predetermined ratio according to a desired target weight (see FIG. 4).

Step (d2): Charge the weight mortar 120 formed through the mixing inside the case 110 in which the metal rod 130 having a ‘U’ shape is temporarily fixed.

Step (d3): Cure the mortar 120 charged as described above for the predetermined time outdoors such that the end 131 of the metal rod 130 having the ‘U’ shape is integrally embedded in the mortar 120, in which a curved portion of the metal rod 130 protruding outside the mortar 120 forms the handle.

A period of the curing may vary according to materials mixed into the mortar 120 and a ratio thereof. Typically, however, rapid curing of the weight 100 having minimum strength may take about 2 days, and general curing of the weight 100 having normal strength may take about 7 days.

Step (f): Perform, after the step (e), finishing by applying a rustproofing paint to a surface of the rectangular case 110 formed of the metal, the filling compound charged inside the case, or the metal rod 130 (post-processing step).

In other words, the paint may be applied to the surface of the case 110, the mortar 120 including the iron powder, or the metal rod 130 to form a paint film, so that air contact may be blocked, which prevent oxidation (rust) of the case 110, the mortar 120, and the metal rod 130.

As described above, the mortar 120 may include the iron powder to add a weight to the weight 100. In this case, the paint may be applied to the surface of the mortar as described above to form the paint film, so that the air contact may be blocked, which prevents oxidation (rust) of the iron powder on the surface of the mortar.

Therefore, according to the elevator weight 100 having the handle, which is manufactured by one of the methods described above, a worker may lift and transport the weight 100 by using the handle provided to the weight, or may install the weight by fitting the handle to the weight fixing frame 200, so that work convenience may be improved.

In addition, work safety may be significantly improved by preventing an accident in which a finger of the worker is caught between the weights 100 in a process of transporting or installing the weight 100 by the worker.

In addition, referring to FIG. 4, the weight 100 may be fixed by fitting the metal rod 130, which serves as the handle of the weight 100 according to the present invention, into a weight fixing frame 200 having a general structure in which a horizontal section has a [symbol] shape.

In addition, a rod-shaped separation prevention support member 300 having a structure that stands vertically and has an open top may be further provided in the weight fixing frame 200 of an elevator.

In this case, the metal rod 130, which serves as the handle of the weight 100, may be simply fitted vertically to the top of the separation prevention support member 300, so that the weight 100 may be fixed more stably so as to be prevented from being separated from the weight fixing frame 200.

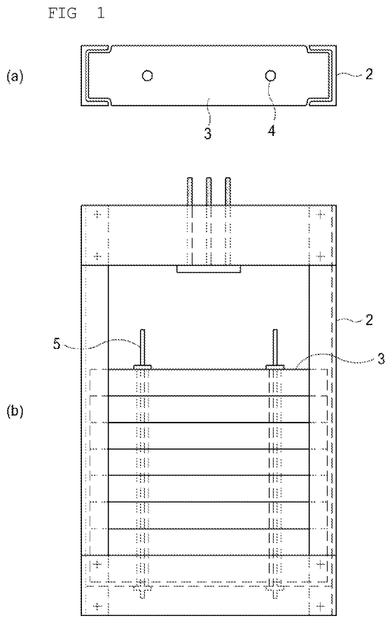

Therefore, as reviewed in FIG. 1, according to a conventional weight 3 having a general shape without a handle, after bolt insertion holes 4 are formed in a middle of a weight, first, while weights 3 having the above structure are fitted and assembled to a weight fixing frame 2, a fixing bolt 5 was fitted and screw-coupled to the bolt insertion hole 4, so that finally, the weight 3 was fixed to the weight fixing frame 2.

However, when compared to the conventional configuration, according to the weight 100 of the present invention, the metal rod 130, which serves as the handle, may be simply fitted to the weight fixing frame 200 or/and the separation prevention support member 300, so that a fixing work for assembly and separation prevention of the weight 100 may be very simple as compared with the related art.

In other words, the weight 100 according to the present invention may be fixed by fitting the metal rod 130, which serves as the handle, to the weight fixing frame 200 having the general structure in which the horizontal section has the ‘L’ shape, or fitting and fixing the metal rod 130 to the separation prevention support member 300, so that the separation prevention support member 300 may replace the weight fixing frame 200, or may be added to the structure of the weight fixing frame 200.

Therefore, the rod-shaped separation prevention support member 300 that stands vertically and has an open top may be further provided in the weight fixing frame 200 of the elevator so as to vertically fit handles of weights 100 to tops of separation prevention support members 300, respectively, so that the weight 100 may be fixed more stably so as to be completely prevented from being separated from the weight fixing frame 200 or the separation prevention support member 300.

Although one embodiment of the present invention has been described above, the present invention is not limited to the specific embodiment described above. In other words, numerous changes and modifications can be made to the present invention by a person having ordinary skill in the art to which the present invention pertains without departing from the idea and scope of the appended claims, and all such appropriate changes and modifications shall be considered as equivalents within the scope of the present invention.

1. A method for manufacturing an elevator weight having handles, the method comprising:
(a) preparing a rectangular case formed of a metal or a resin-based material and having an empty interior;
(b) forming a pair of through-holes for fixing a handle on side surfaces of both ends of the case;
(c) inserting an end of a metal rod having a predetermined shape by a predetermined depth into the pair of through-holes formed in the step (b), and temporarily fixing the metal rod to the case;
(d) charging a filling compound inside the case in which the metal rod is temporarily fixed; and
(e) curing, after the step (d), charged mortar for a predetermined time outdoors such that the end of the temporarily-fixed metal rod is integrally embedded in the mortar, in which a portion of the metal rod protruding outside the mortar forms the handle.

2. The method of claim 1, wherein, in the step (c), an overall shape of the metal rod is a ‘U’ shape, a [symbol] shape, or a [symbol] shape so that both ends of the metal rod having the ‘U’ shape, the [symbol] shape, or the [symbol] shape are inserted by the predetermined depth into the pair of through-holes formed in the step (b), and the metal rod is temporarily fixed to the case.

3. The method of claim 1, wherein the step (d) includes:
(d1) forming a weight mortar through mixing by inputting water and iron powder to cement at a predetermined ratio according to a desired target weight;
(d2) charging the weight mortar, formed through the mixing inside the case in which the end of the metal rod is temporarily fixed; and
(d3) curing the charged mortar for the predetermined time outdoors such that the end of the temporarily-fixed metal rod is integrally embedded and fixed in the mortar.

4. The method of claim 1, further comprising:
(f) a post-processing step of performing, after the step (e), finishing by applying a rustproofing paint to a surface of the rectangular case formed of the metal, the filling compound charged inside the case, or the metal rod.

5. The method of claim 2, wherein a screw thread is formed on circumferential surfaces of the both ends of the metal rod having the ‘U’ shape, the [symbol] shape, or the [symbol] shape, and a temporarily fixing nut is screw-coupled to the screw thread while the both ends of the metal rod on which the screw thread is formed are inserted by the predetermined depth into the pair of through-holes, so that the metal rod having the ‘U’ shape, the [symbol] shape, or the [symbol] shape is temporarily fixed to the case.

6. The method of claim 2, wherein the through-hole and a circumference of the round rod inserted into the through-hole are welded to each other while the both ends of the metal rod having the ‘U’ shape, the [symbol] shape, or the [symbol] shape are inserted by the predetermined depth, so that the metal rod is temporarily fixed to the case.

7. An elevator weight having a handle, which is manufactured by the method of claim 1.

8. The elevator weight of claim 7, wherein an elevator is further provided with rod-shaped separation prevention support members, and metal rods, which serve as handles for a weight, are fitted to the separation prevention support members, respectively, so that the weight is fixed so as to be prevented from being separated from the separation prevention support member.

9. The elevator weight of claim 8, wherein a weight fixing frame is further provided at a periphery of the rod-shaped separation prevention support member, and the metal rods, which serve as the handles for the weight, are fitted to the separation prevention support members, respectively, so that the weight is fixed so as to be prevented from being separated from the separation prevention support member and the weight fixing frame.
